(19) United States
(12) Patent Application Publication
(10) Pub. No.: US 2008/0056852 A1
(43) Pub. Date: Mar. 6, 2008

(54) METHOD FOR ASSEMBLING NOTEBOOKS

(75) Inventors: Richard H. Harris, Beavercreek, OH (US); Thomas Scott Walker, Kettering, OH (US)

Correspondence Address: THOMPSON HINE L.L.P.;Intellectual Property Group, P.O. BOX 8801, DAYTON, OH, 45401-8801, US

(73) Assignee: MEADWESTVACO CORPORATION, Glen Allen, VA (US)

(21) Appl. No.: 11/847,860

(22) Filed: Aug. 30, 2007

Related U.S. Application Data
(60) Provisional application No. 60/841,076, filed on Aug. 30, 2006.

(51) Int. Cl. B42B 5/12

(52) U.S. Cl. 412/39

(57) ABSTRACT

A method for assembling a notebook including the step of storing a plurality of covers having generally the same size and shape, each cover including a front panel, a rear panel, and a flexible portion positioned between the front and rear panels. The method also includes storing a plurality of differently-sized binding mechanisms and receiving an order for a particularly-sized notebook. The method includes, in response to the order, accessing one of the covers and one of the binding mechanisms corresponding to the ordered notebook. The method further includes the step of joining the accessed cover and the accessed binding mechanism such that the flexible portion of the cover is located immediately adjacent to the binding mechanism and allows the cover to conform to the particular size of the associated binding mechanism when the notebook is in a closed position.

This application claims priority to provisional Patent Application Ser. No. 60/841,076, entitled Method for Manufacturing Notebooks, filed on Aug. 30, 2006. The entire contents of that provisional application are incorporated by reference herein.

The present invention is directed to a method for assembling notebooks, and more particularly, to a method for assembling various sized notebooks.

### BACKGROUND

Notebooks are widely used as a device for storing and dispensing paper. Such notebooks typically include a binding mechanism, such as a spiral wire or twin-wire binding mechanism, to bind the papers together and to the cover of the notebook.

### SUMMARY

In one embodiment, the invention is a method for assembling a notebook including the step of storing a plurality of covers having generally the same size and shape, each cover including a front panel, a rear panel, and a flexible portion positioned between the front and rear panels. The method also includes storing a plurality of differently-sized binding mechanisms and receiving an order for a particularly-sized notebook. The method includes, in response to the order, accessing one of the covers and one of the binding mechanisms corresponding to the ordered notebook. The method further includes the step of joining the accessed cover and the accessed binding mechanism such that the flexible portion of the cover is located immediately adjacent to the binding mechanism and allows the cover to conform to the particular size of the associated binding mechanism when the notebook is in a closed position.

### BRIEF DESCRIPTION OF THE DRAWINGS

FIG. 1 is a front perspective view of one embodiment of the notebook of the present invention, shown in its closed position;

FIG. 2 is a front perspective view of the notebook of FIG. 1, shown in its open position;

FIG. 3 is a front perspective view of the notebook of FIG. 2, with the binding mechanism and papers exploded away from the cover;

FIG. 4 is an end view of the notebook of FIG. 1;

FIG. 5 is an end view of the notebook of FIG. 4 utilizing a larger binding mechanism;

FIG. 6 is a top view of a blank which can be used to form the cover of FIGS. 1-5; and

FIG. 7 is a flow chart illustrating a method for assembling notebooks.

### DETAILED DESCRIPTION

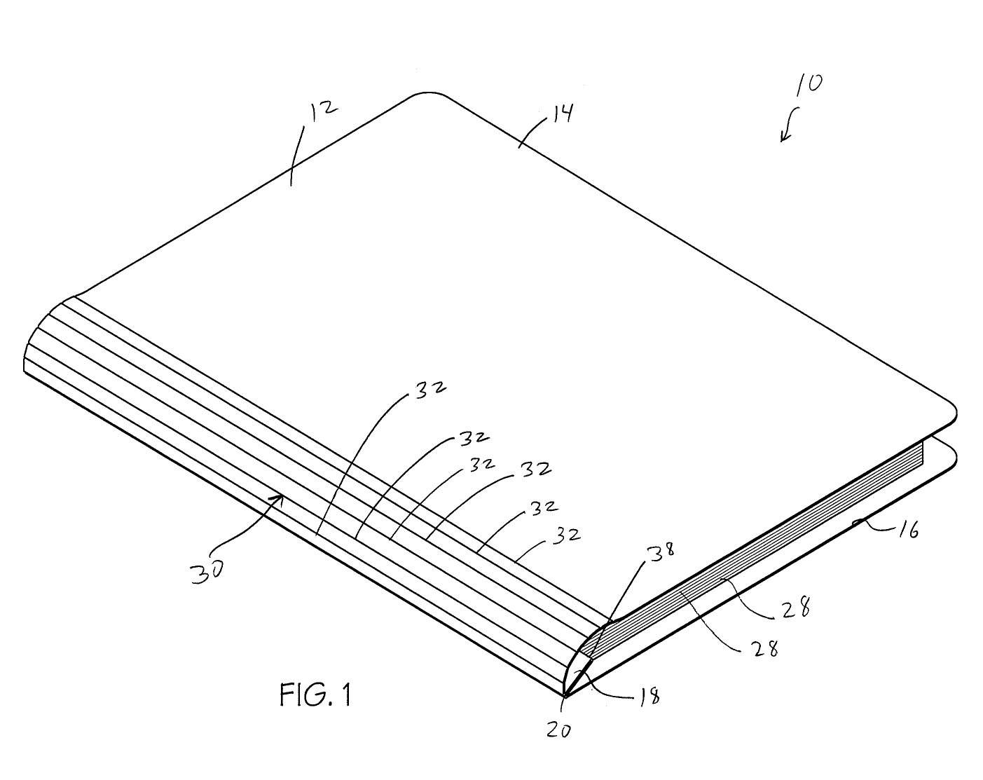

As shown in FIGS. 1-5, in one embodiment the notebook 10 of the present invention includes a cover 12 including front panel 14 and a rear panel 16 pivotally joined together. The cover 12 may include an inwardly-extending tab 18 coupled to the front 14 and rear 16 panels. In the illustrated embodiment, the tab 18 is pivotally coupled to the rear panel 16 along a fold line 20 and includes a plurality of openings 22 extending along its length thereof.

The notebook 10 includes a binding mechanism 24, such as a spiral wire or twin-wire binding mechanism. The binding mechanism 24 has a plurality of turns or coils, each of which is received through a corresponding opening 22 in the tab 18 to couple the binding mechanism 24 to the cover 12. Each turn or coil of the binding mechanism 24 may also extend through a hole 26 in a sheet of paper 28 to bind the papers 28 to the cover 12. If desired, the pages 28 may be lined or ruled (not shown).

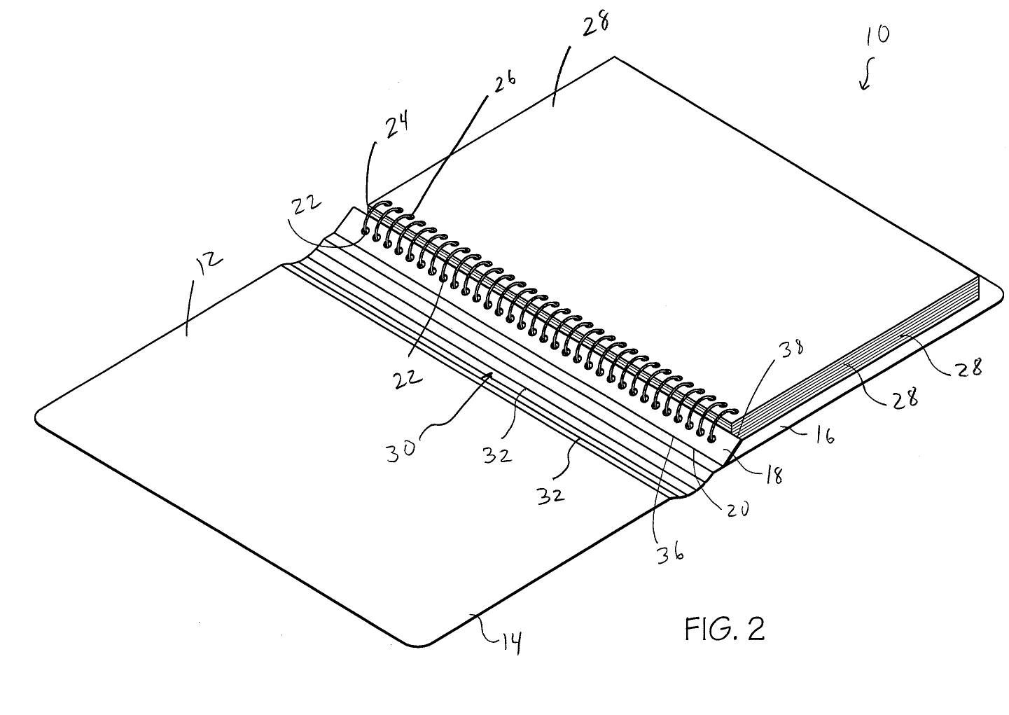

The cover 12 includes a flexible portion 30 located between the front panel 14 and the tab 18/rear panel 16. In the illustrated embodiment, the flexible portion 30 includes a plurality of parallel equally spaced-apart fold lines 32 extending the entire height of the cover 12/flexible portion 30. The fold lines 32 can be crease lines, thinned, removed or compressed areas of the cover material, lines of weakness, or the like, such that the cover 12 is predisposed to fold around the fold lines 32. The flexible portion 30 can have a variety of widths (i.e., in the generally left-to-right dimension of FIGS. 2, 3 and 6, or extending perpendicular to the binding mechanism 24), but in one embodiment has a width of at least about 0.5 inches, or at least about ¾ inch, or at least about 1 inch, or at least about 3%, or at least about 5%, or at least about 10% of the width of the front 14 and/or rear 16 panel. The flexible portion 30 may extend across the entirety of the height dimension of the cover 12, and each fold line 32 may extend the entire height of the flexible portion 30.

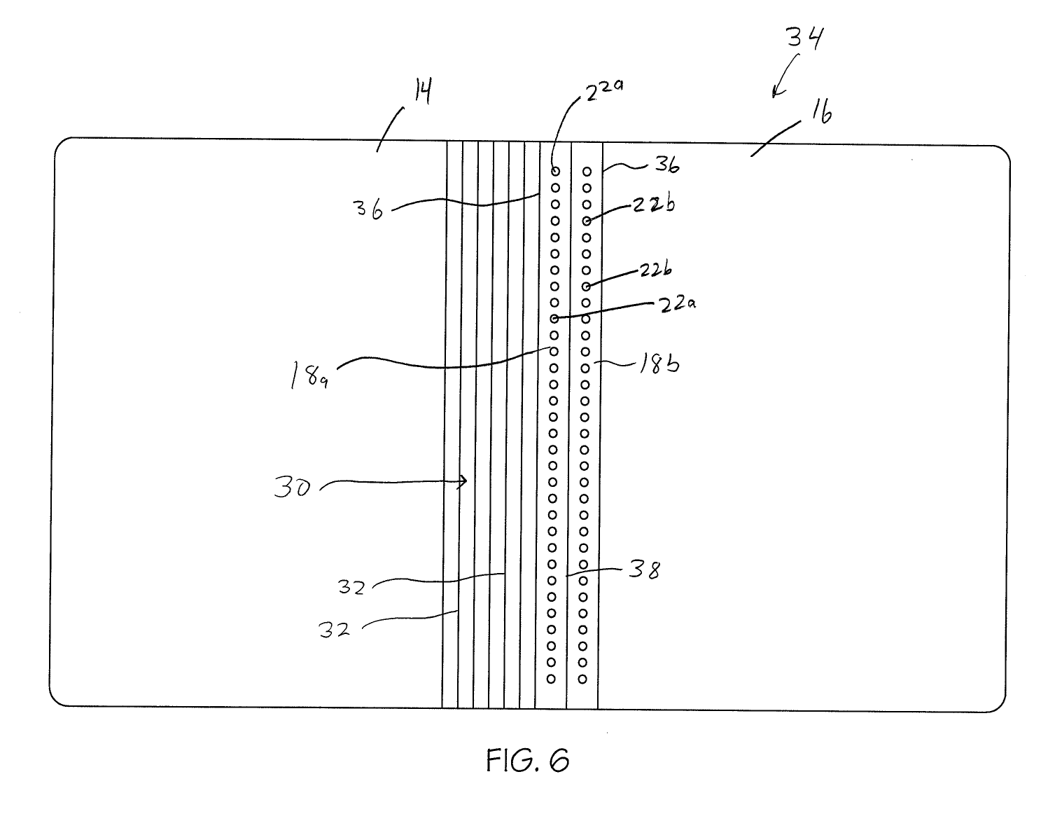

In order to assemble the cover 12, a blank 34 as shown in FIG. 6 may be supplied. The blank 34 can be made of a variety of materials, such as plastic (i.e., polypropylene), cardboard, paperboard, or combinations of these materials. The fold lines 32 can be formed by a variety of methods. However, in one embodiment, when the blank 34 is made of die-cut plastic, the cutting die used to die-cut the plastic may include portions which compress or score the blank 34 as the blank 34 is formed to also form the fold lines 32. Thus in the die-cut process the die defines the outer perimeter of the blank 34, and also simultaneously forms the fold lines 32 (as well as any other fold lines, if desired). This allows the blank 34 to be formed in a single cutting stroke and improves speed and efficiency of manufacture. The blank 34 may also include a pair of fold lines 36 adjacent to, and defining, the tab 18 (and tab portions 18a, 18b).

After the blank 34 is provided, the tab portions 18a, 18b are folded together about central fold line 38 and joined, such as by heat welding, adhesive heat welding, heat staking, sonic welding, adhesives, mechanical means or the like to form the tab 18. In the embodiment of FIG. 6, the tab portions 18a, 18b each include a set of holes 22a, 22b formed therein. After the tab portions 18a, 18b are folded about the center fold line 38 and brought together, the holes 22a, 22b are aligned to form a single associated hole 22. Alternately, if desired, the holes 22 may be formed after the tab portions 18a, 18b are joined.

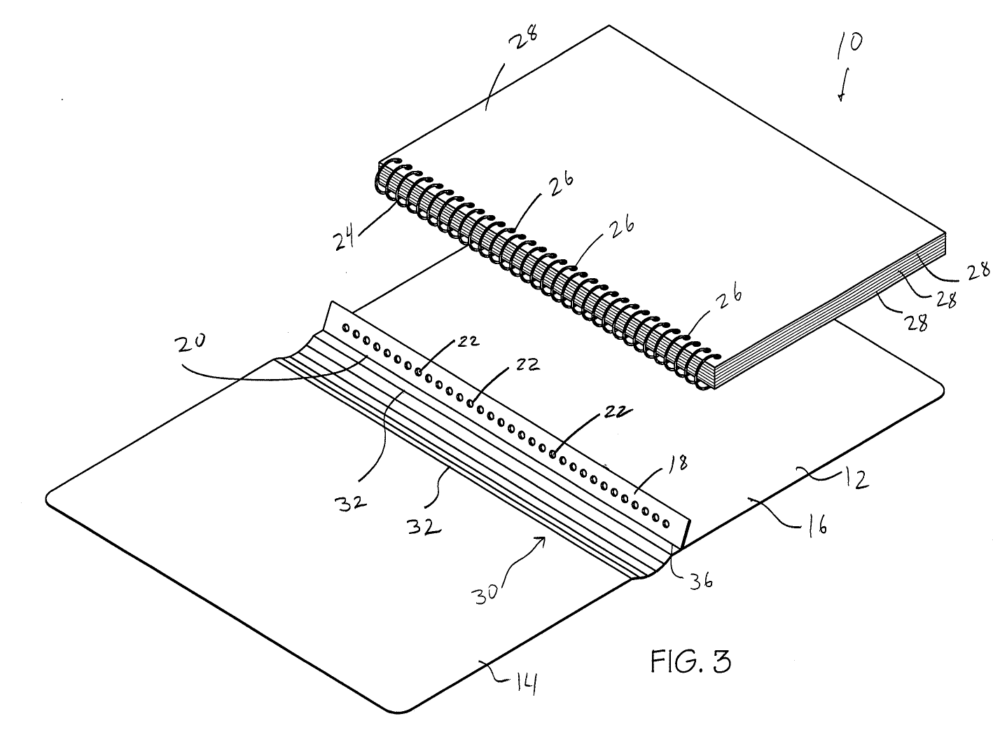

Next, a binding mechanism 24 with (or optionally without) papers 28 bound thereto, can be procured/provided as shown in FIG. 3. The binding mechanism 24 can then be coupled to the cover 12, for example, by passing the binding mechanism 24 through the openings 22 of the tab 18. The front panel 12 and flexible portion 30 can then be folded about the binding mechanism 24 and papers 18 to move the notebook to the closed position, as shown in FIG. 1.

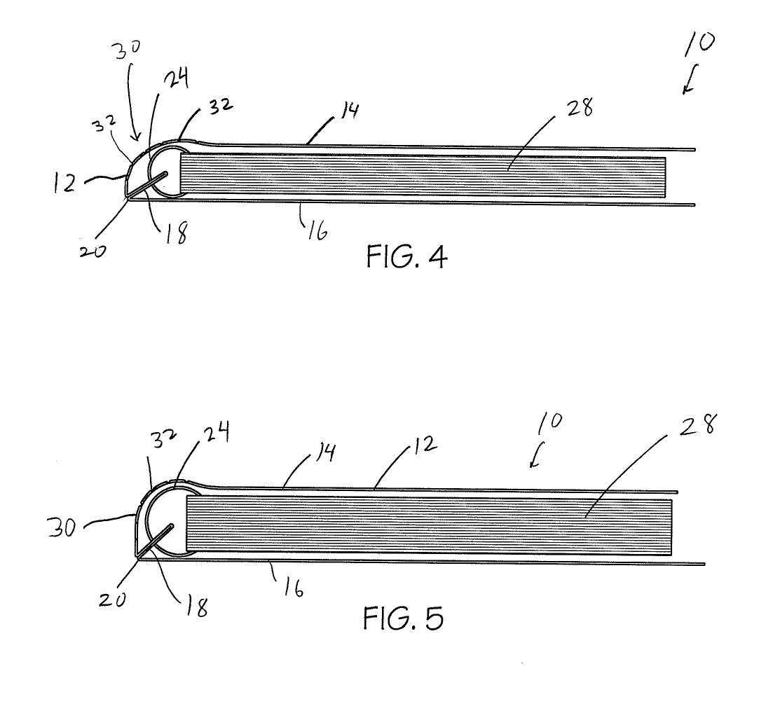

The flexible portion 30 allows the cover 12 to accommodate various-sized binding mechanisms 24. For example, FIG. 4 illustrates the cover 12 bound to a relatively small binding mechanism 24, and FIG. 5 illustrates the cover 12 bound to a relatively large binding mechanism 24. The flexible portion 30 allows the cover 12 to generally conform around the differently-sized binding mechanisms 24 such that when the cover 12 is closed the front 14 and rear 16 panels are generally parallel, thereby allowing various differently sized (i.e., ⅜ inch, ½ inch, or ⅝ inch diameter) binding mechanisms 24 to be utilized to provide differently-sized notebooks 10.

The ability of the cover 12 to accept various-sized binding mechanisms 24 may be of great benefit to a manufacturer/assembler. For example, it may be cost effective, for various reasons, to obtain covers 12 and binding mechanisms 24/papers 28 at different times and/or from different vendors or suppliers. The assembler/manufacturer can then inventory or store a large number of covers 12 and various-sized binding mechanisms 24 which are not coupled to a cover 12. Once an order for notebooks is received, the covers 12 and appropriately sized binding mechanisms 24 can be accessed and assembled in a rapid manner.

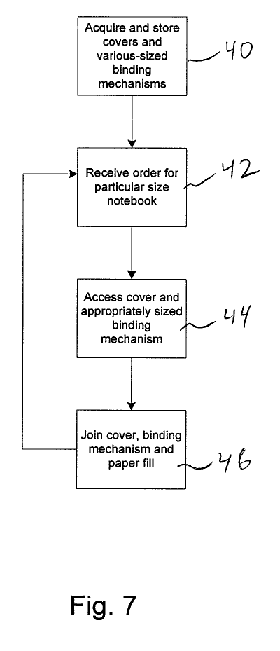

For example, as shown in FIG. 7, at step 40 various covers 14 and differently-sized binding mechanisms 24 can be acquired and stored. The covers 14 and binding mechanisms 24 may be acquired from vendors or suppliers, or can manufactured by the same entity which does the storing and/or assembly. Once an order for a particular size notebook (presumably for a plurality of notebooks) is received at step 42, the covers 12 and appropriately sized binding mechanism 24 are pulled from storage (step 44). The covers 12 and associated binding mechanisms 24 are joined (in step 46), in one case providing the notebook 10 shown in FIGS. 1-5 and described above.

The binding mechanisms 24 may have paper 28 carried thereon before or after being coupled to the covers 12. Thus the binding mechanisms 24 may be stored with paper 28 bound thereon, or the paper 28 may be bound to the binding mechanisms 24 after the binding mechanisms 24 are pulled from storage of after the binding mechanisms 24 are coupled to the covers 12. Moreover, the binding mechanisms 24 may be purchased, manufactured, or acquired with or without the papers 28 bound thereon.

The use of the cover 14 of the present invention allows the manufacturer/assembler to store/inventory only a single size cover 12 which is adaptable to be used with various differently-sized binding mechanisms 24. This also allows a manufacturer to store a relatively low number of covers 12, thereby reducing inventory and storage costs. Thus the method described herein and shown in FIG. 7 provides a flexible and modular assembling process which allows quick and efficient processing of orders with relatively low costs.

Moreover, duties or tariffs can be imposed on imported paper products, such as lined or ruled paper products, and such duties or tariffs can be relatively high. These duties or tariffs may not apply, or may be lesser, for other components such as covers and/or binding mechanisms that do not qualify as paper products, or ruled or lined paper products, for duty or tariff purposes. Accordingly it may be more cost effective to import or manufacture the covers 12/and/or binding mechanisms 24 separate from the papers 28 to minimize the total value of products which are classified as paper products, or lined or ruled paper products.

For example, it may be more cost effective for a domestic company to import the covers 12 and/or binding mechanism 24, and then bind the papers 28 thereto. Further alternately, it may be cost effective to import the covers 12, and then manufacture or domestically acquire the binding mechanisms 24 with the papers 28 bound thereto, and bind the binding mechanisms 24/papers 28 to the imported covers 12. It may also be cost effective to import the covers 12 separately from the binding mechanisms 24 with papers 28 bound thereto. In all cases, however, only a single size of covers 12 need to be manufactured/acquired/stored, as the covers 12 can accommodate differently-sized binding mechanisms 24 and thicknesses of papers 28. The single-sized cover 12 allows the differing components of the notebook 10 to reach the assembly stage by differing routes but still ensures compatibility and flexibility in manufacturing/assembly. Since binding mechanisms 24 are often manufactured/assembled with the papers 28 bound thereon, and notebooks are often imported in a fully assembled condition, this method represents a departure from traditional assembly methods.

The flexible portion 30 is illustrated as being formed of the same materials as the front 14 and rear panels 16, with flexibility being imparted to the flexible portion 30 by a plurality of parallel fold lines 32. However, it should be noted that the flexible portion 30 can be made of a material or materials that are different from the front 14 or rear 16 panels, such as nearly any material which has sufficient flexibility and conformity to allow the flexible portion 30 to naturally somewhat conform to the shape of the binding mechanism 24 when the notebook 10 is closed, and to allow the front 14 and rear 16 panels to be generally parallel. In one embodiment, the flexible portion 30 may merely have more flexibility than the front 14 or rear 16 panels.

In addition, it should be understood that various other binding mechanisms 24 besides the single wire or twin wire binding mechanisms described above may be utilized. For example, a three-ring binding mechanism, or various prongs, clips, book-style bindings, adhesives and the like may be utilized. In addition, the notebook 10 may not necessarily include the inwardly-extending tab 18, and the binding mechanism 24/papers 28 could instead be directly bound to the front panel 14, rear panel 16, a spine of the cover 12 or the like. However, the use of inwardly-extending tab 18 provides a surface which is sufficiently durable and flexible to accommodate a relatively large variety of sizes of binding mechanisms, and allows the binding mechanism 24 to be protected.

Having described the invention in detail and by reference to the preferred embodiments, it will be apparent that modifications and variations thereof are possible without departing from the scope of the invention.

What is claimed is:

1. A method for assembling a notebook comprising the steps of:
storing a plurality of covers having generally the same size and shape, each cover including a front panel, a rear panel, and a flexible portion positioned between the front and rear panels;
storing a plurality of differently-sized binding mechanisms;
receiving an order for a particularly-sized notebook;
in response to said order, accessing one of said covers and one of said binding mechanisms corresponding to said ordered notebook; and
joining said accessed cover and said accessed binding mechanism such that the flexible portion of said cover is located immediately adjacent to the binding mechanism and allows the cover to conform to the particular size of the associated binding mechanism when the notebook is in a closed position.

2. The method of claim 1 wherein said flexible portion of each cover includes a plurality of fold lines formed therein to lend flexibility to said flexible portion.

3. The method of claim 1 wherein said flexible portion extends across the entirety of a height dimension of said cover, and wherein each fold line extends the entire height of said flexible portion.

4. The method of claim 1 wherein said front panel, said rear panel, and said flexible portion of each cover is made of a single unitary sheet of material.

5. The method of claim 4 wherein said flexible portion of each cover includes a plurality of fold lines defined by compressed lines or score lines formed in said sheet of materials.

6. The method of claim 5 wherein each cover is formed by a die-cut process in a single step which defines the outer edges of said cover and simultaneously forms said plurality of fold lines.

7. The method of claim 1 wherein each cover includes an inwardly-extending tab positioned adjacent to said flexible portion, and wherein said joining step includes directly joining said binding mechanism to said inwardly-extending tab.

8. The method of claim 7 wherein said binding mechanism is a wire binding mechanism, and wherein said inwardly-extending tab includes a plurality of openings formed therein, and wherein said joining step includes passing a turn of said wire binding mechanism through each opening.

9. The method of claim 7 wherein said tab is made of a two-ply material.

10. The method of claim 1 wherein each binding mechanism of said storing step includes a plurality of papers bound thereto.

11. The method of claim 1 wherein said flexible portion extends across the entirety of a height dimension of said cover, and wherein said front and rear panels each have a width extending generally perpendicular to said height dimension, and said flexible portion has a width of at least about 3% of the width one of said front or rear panels.

12. The method of claim 1 wherein both of said storing steps and said joining step are carried out domestically, and wherein at least one of said covers or said binding mechanisms are manufactured non-domestically and imported after manufacture, and wherein said at least one of said imported covers or binding mechanisms lack sufficient paper items coupled thereto such that said imported covers or binding mechanisms do not trigger import tariffs or duties associated with paper products.

13. The method of claim 1 further comprising the steps of:
receiving another order for a notebook of a different size than said particularly-sized notebook;
in response to said another order, accessing one of the covers and accessing a binding mechanisms having a differing size than the originally accessed binding mechanism; and
joining said accessed binding mechanism to said associated cover such that the flexible portion is located immediately adjacent to the binding mechanism and allows the cover to conform to the associated binding mechanism when the notebook is in a closed position to form a differently-sized notebook.
